(19) United States
(12) Patent Application Publication
(10) Pub. No.: US 2009/0066497 A1
(43) Pub. Date: Mar. 12, 2009

(54) Automotive Tire Pressure Monitoring System

(76) Inventors: Keith A. Christenson, Canton, MI (US); Jason Summerford, Novi, MI (US); John Nantz, Brighton, MI (US); William K. Cotton, Fenton, MI (US)

Correspondence Address: DICKINSON WRIGHT PLLC, Suite 2000, 38525 Woodward Avenue, Bloomfield Hills, MI, 48304-5092, US

(21) Appl. No.: 11/853,829

(22) Filed: Sep. 12, 2007

(51) Int. Cl. B60C 23/02

(52) U.S. Cl. 340/442

(57) ABSTRACT

An automotive tire pressure monitoring system is provided including a group of tire pressure monitor sensors each comprising a pressure sensor element, a dual-axis accelerometer, and a transmitter generating a pressure signal including accelerometer information. A front antenna and a rear antenna are both in communication with a tire pressure monitoring receiver. The tire pressure monitoring receiver includes logic adapted to: determine a pressure signals left/right designation from the accelerometer information and determine a pressure signal's front/rear designation using comparative signal strength from the front antenna and the rear antenna.

### TECHNICAL FIELD

The present invention relates generally to a tire pressure monitoring system and more particularly to a tire pressure monitoring system using dual antennas with a single receiver module.

### BACKGROUND OF THE INVENTION

Automotive design has adapted to incorporate an ever increasing range of convenience and safety features. These features are located throughout the vehicle. While many of the electronic features are positioned with easy access to centralized processors, there are some features whose location and functionality requires remote location.

One such feature is the tire pressure monitoring system. These system must register pressure within a vehicles tire. As such, the sensors within the rotating wheel must communicate wirelessly with a remote receiver. Furthermore, the receiver must have the ability to discriminate from the sensor in each wheel independently to properly inform the driver. Therefore, existing systems often incorporate complex signal triggers and identification signals to isolate one pressure sensor signal from another. These sensors are costly and complex. Furthermore, replacement during the vehicle life cycle can require costly reconfiguration of the main receiver system.

An additional concern involves the standardization of pressure sensor signal frequencies. As the majority of vehicles begin to utilize TPM systems operating at identical frequencies, simultaneous transmissions from nearby vehicles can result in radio frequency collisions that lose the tire data. It would be highly desirable to reduce the power of the sensor signals in order to reduce incidents of interference.

As such it would be highly desirable to have a tire pressure monitoring system that could be inexpensively and simply implemented. It would also be highly desirable for such a tire pressure monitoring system to minimize the chance for interference with nearby vehicles.

### SUMMARY OF THE INVENTION

In accordance with the desires of the present invention an automotive tire pressure monitoring system is provided including a group of tire pressure monitor sensors each comprising a pressure sensor element, a dual-axis accelerometer, and a transmitter generating a pressure signal including accelerometer information. A front antenna and a rear antenna are both in communication with a tire pressure monitoring receiver. The tire pressure monitoring receiver includes logic adapted to: determine a pressure signals left/right designation from the accelerometer information and determine a pressure signal's front/rear designation using comparative signal strength from the front antenna and the rear antenna.

Other objects and features of the present invention will become apparent when viewed in light of the detailed description and preferred embodiment when taken in conjunction with the attached drawings and claims.

### BRIEF DESCRIPTION OF THE DRAWINGS

FIG. 1 is an illustration of a tire pressure monitoring system in accordance with the present invention.

FIG. 2 is a detail illustration of a tire pressure sensor for use in the tire pressure monitoring system illustrated in FIG. 1.

### DESCRIPTION OF PREFERRED EMBODIMENTS

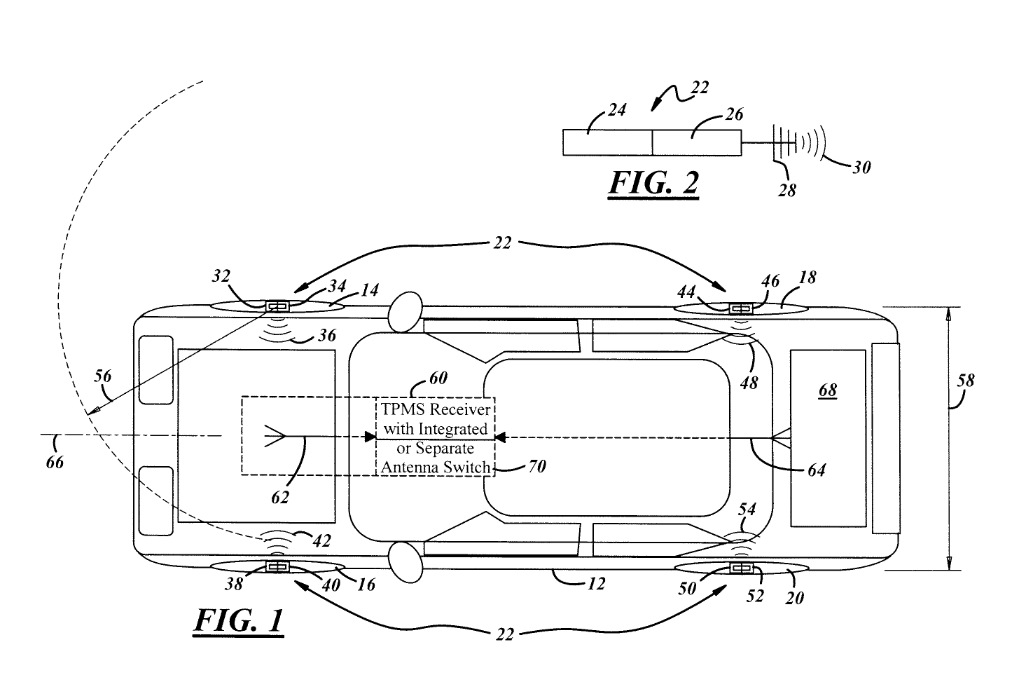

Referring now to FIG. 1, which is an illustration of a tire pressure monitoring system 10 in accordance with the present invention. The tire pressure monitoring system 10 is illustrated mounted within an automobile 12. Although a particular vehicle is illustrated, it should be understood that the present invention is contemplated for use in a wide variety of vehicles. The automobile 12 includes a right front tire 14, a left front tire 16, a right rear tire 18 and a left rear tire 20. The present invention provides a tire pressure monitoring system 10 that in a unique and novel fashion is able to identify the tire pressure within each of the automotive tires 14-20 without the need for complex triggers or initiator signals.

The tire pressure monitoring system 10 includes a group of tire pressure monitor sensors 22 each of which comprises a pressure sensor element 24, a dual-axis accelerometer 26, and a transmitter 28. (See FIG. 2). The transmitter 28 generates a pressure signal 30 including accelerometer information. The group 22 preferably includes a right front tire pressure sensor 32 including a right front dual-axis accelerometer 34 and generating a first pressure signal 36, a left front tire pressure sensor 38 including a left front dual-axis accelerometer 40 and generating a second pressure signal 42, a right rear tire pressure sensor 44 including a right rear dual-axis accelerometer 46 and generating a third pressure signal 48, and a left rear tire pressure sensor 50 including a left rear dual-axis accelerometer 52 and generating a fourth pressure signal 54. The right front tire pressure sensor 32, the left front tire pressure sensor 38, the right rear tire pressure sensor 44 and the left rear tire pressure sensor 50 are mounted within the right front tire 14, the left front tire 16, the right rear tire 18 and the left rear tire 20 respectively.

The group of tire pressure monitor sensors 22 are preferably trigger less sensors who do not require an initiator signal to broadcast. This significantly reduces their complexity and cost. In addition, the sensors 22 preferably incorporate low power transmission such that their effective transmission radius 56 is less than a vehicle width 58 to minimize interference with nearby vehicles. In at least one embodiment it is contemplated that the transmission radius 56 be between half a vehicle width 58 and a vehicle width 58.

The present invention incorporates a tire pressure monitoring receiver 60 mounted within the automobile 12. The tire pressure monitoring receiver 60 is in communication with a front antenna 62 and a rear antenna 64. The front antenna is preferably mounted near the vehicle centerline 66 in close proximity to the right front tire pressure sensor 32 and the left front tire pressure sensor 38. The rear antenna 64 is preferably mounted near the vehicle centerline 66 in close proximity to the right rear tire pressure sensor 44 and the left rear tire pressure sensor 50. In one embodiment it is contemplated that the rear antenna 64 may be mounted within the vehicle trunk 68. Although the front antenna 62 and the rear antenna 64 may be independent and mounted remotely from the tire pressure monitoring receiver 60, in is contemplated that one of them may be integrated into the tire pressure monitoring receiver 60. In FIG. 1, the front antenna 62 is illustrated integrated into the tire pressure monitoring receiver 60. In this scenario, the tire pressure monitoring receiver 60 is preferably mounted in proximity to the right front tire pressure sensor 32 and the left front tire pressure sensor 38. Although a variety of antenna configurations may be utilized for either the front antenna 62 or the rear antenna 64, it is specifically contemplated that they could be formed as a monopole antenna or a resonant loop antenna.

The tire pressure monitoring receiver 60 receives signals 36,42,48,54 from the front antenna 62 and the rear antenna 64. The tire pressure monitoring receiver 60 incorporates logic adapted to determine the signals front/rear designation using comparative signal strength from the front antenna 62 and rear antenna 64. In one embodiment this is contemplated to be achieved through the use of a simple received signal strength indicator circuitry (RSSI). In another embodiment it is contemplated that the tire pressure monitoring receiver 60 includes a switch element 70. The switch element 70 allows the tire pressure monitoring receiver 60 to independently poll the front antenna 62 and rear antenna 64 to determine comparative signal strength. This allows the tire pressure monitoring receiver 60 to determine of the signal come from the front sensors 32,38 or the rear sensor 44,50.

The tire pressure monitoring receiver 60 further includes logic adapted to determine the signals left/right designation from the accelerometer information contained in the pressure signal 30. The accelerometer information produced by the dual-axis accelerometer 26 will vary dependent on vehicle dynamics and the left/right designation of the sensor. By way of example, during a left hand turn the right front dual-axis accelerometer 34 will experience a greater rotational speed than the left front dual-axis accelerometer 40. In this fashion, it is possible for the logic to determine a left/right designation from the accelerometer information contained in the pressure signal 30.

The present invention accomplishes pressure sensor signal location without complex sensors or unique identification signals. The present invention allows for the use of trigger less sensors and removes the necessity of initiator signals. Finally, the present invention allows for the use of low power transmissions which reduce interference with nearby vehicles.

While the invention has been described in connection with one or more embodiments, it is to be understood that the specific mechanisms and techniques which have been described are merely illustrative of the principles of the invention, numerous modifications may be made to the methods and apparatus described without departing from the spirit and scope of the invention as defined by the appended claims.

What is claimed is:

1. An automotive tire pressure monitoring system comprising:
a group of tire pressure monitor sensors each comprising a pressure sensor element, a dual-axis accelerometer, and a transmitter generating a pressure signal including accelerometer information, said group comprising:
a right front tire pressure sensor including a right front dual-axis accelerometer, said right front tire pressure sensor generating a first pressure signal;
a left front tire pressure sensor including a left front dual axis accelerometer, said left front tire pressure sensor generating a second pressure signal;
a right rear tire pressure sensor including a right rear dual-axis accelerometer, said right rear tire pressure sensor generating a third pressure signal;
a left rear tire pressure sensor including a left rear dual axis accelerometer, said left rear tire pressure sensor generating a fourth pressure signal;
a tire pressure monitoring receiver;
a front antenna and a rear antenna both in communication with said tire pressure monitoring receiver, said front antenna mounted in proximity to said right front tire pressure sensor and said left front tire pressure sensor, said rear antenna mounted in proximity to said right rear tire pressure sensor and said left rear tire pressure sensor, said tire pressure monitoring receiver including logic adapted to:
determine a pressure signals left/right designation from said accelerometer information; and
determine a pressure signal's front/rear designation using comparative signal strength from said front antenna and said rear antenna.

2. An automotive tire pressure monitoring system as described in claim 1, wherein each of said group of tire pressure monitor sensors comprises a trigger-less sensor.

3. An automotive tire pressure monitoring system as described in claim 1, wherein each of said transmitters comprises a low-power transmitter optimized to reduce external vehicle interference.

4. An automotive tire pressure monitoring system as described in claim 1, wherein each of said transmitters comprises an effective transmission radius less than a vehicle width.

5. An automotive tire pressure monitoring system as described in claim 1, further comprising:
a switch element in communication with said front antenna and said rear antenna, said logic adapted to use said switch element to independently poll said front antenna and said rear antenna.

6. An automotive tire pressure monitoring system as described in claim 1, wherein:
said front antenna is integrated into said tire pressure monitoring receiver;
said tire pressure monitoring receiver is positioned in proximity to said right front tire pressure sensor and said left front tire pressure sensor; and
said rear antenna is positioned remotely from said tire pressure monitoring receiver.

7. An automotive tire pressure monitoring system as described in claim 1, wherein said tire pressure monitoring receiver produces no initiator signals.

8. An automotive tire pressure monitoring system as described in claim 1, wherein said rear antenna comprises a monopole antenna.

9. An automotive tire pressure monitoring system as described in claim 1, wherein said rear antenna comprises a resonant loop antenna.

10. A method as described in claim 1, wherein said sound logic uses a received signal strength indicator circuit to determine a pressure signal's front/rear designation.

11. An automotive tire pressure monitoring system comprising:
a group of tire pressure monitor sensors each comprising a pressure sensor element, a dual-axis accelerometer, and a transmitter generating a pressure signal including accelerometer information, said group comprising:
a right front tire pressure generating a first pressure signal;
a left front tire pressure sensor generating a second pressure signal;
a right rear tire pressure sensor generating a third pressure signal;
a left rear tire pressure sensor generating a fourth pressure signal;
a tire pressure monitoring receiver;
a front antenna and a rear antenna both in communication with said tire pressure monitoring receiver, said tire pressure monitoring receiver including logic adapted to:
determine a pressure signals left/right designation from said accelerometer information; and
determine a pressure signal's front/rear designation using comparative signal strength from said front antenna and said rear antenna.

12. An automotive tire pressure monitoring system as described in claim 11, wherein each of said group of tire pressure monitor sensors comprises a trigger-less sensor.

13. An automotive tire pressure monitoring system as described in claim 11, wherein each of said transmitters comprises an effective transmission radius less than a vehicle width.

14. An automotive tire pressure monitoring system as described in claim 11, further comprising:
a switch element in communication with said front antenna and said rear antenna, said logic adapted to utilize said switch element to independently poll said front antenna and said rear antenna.

15. An automotive tire pressure monitoring system as described in claim 14, wherein said sound logic further utilizes a received signal strength indicator circuit to determine a pressure signal's front/rear designation.

16. An automotive tire pressure monitoring system as described in claim 11, wherein:
said front antenna is integrated into said tire pressure monitoring receiver; and
said rear antenna is positioned remotely from said tire pressure monitoring receiver.

17. An automotive tire pressure monitoring system as described in claim 11, wherein said tire pressure monitoring receiver produces no initiator signals.

18. A method of monitoring tire pressure comprising:
transmitting pressure signals including accelerometer information from each of a group of tire pressure monitor sensors, each tire pressure monitor sensor comprising a pressure sensor element, a dual-axis accelerometer, and a transmitter;
receiving said pressure signals using a tire pressure monitoring receiver, said tire pressure monitoring receiver in communication with a front antenna and a rear antenna;
determining a pressure signal's left/right designation from said accelerometer information; and
determining a pressure signal's front/rear designation using comparative signal strength from said front antenna and said rear antenna.

19. A method as described in claim 18, wherein said comparative signal strength is determined by:
using a switch element to independently poll said front antenna and said rear antenna.

20. A method as described in claim 18, wherein said comparative signal strength is determined by using a received signal strength indicator circuit.
